(19) United States
(12) Patent Application Publication
(10) Pub. No.: US 2023/0216691 A1
(43) Pub. Date: Jul. 6, 2023

(54) METHOD, APPARATUS, AND SYSTEM FOR PROVIDING TRANSACTION PROOF OF LOCATION

(71) Applicant: HERE Global B.V., Eindhoven (NL)

(72) Inventors: Yao LI, Chicago, IL (US); Justin EYLANDER, Chicago, IL (US)

(21) Appl. No.: 18/091,739

(22) Filed: Dec. 30, 2022

Related U.S. Application Data
(60) Provisional application No. 63/295,107, filed on Dec. 30, 2021.

(51) Int. Cl. H04L 9/32

(52) U.S. Cl. CPC H04L 9/3247; H04L 9/3297

(57) ABSTRACT

An approach is provided for generating a transaction proof of location. The approach, for example, involves collecting sensor data from one or more sensors of a device at a time, a location, or a combination thereof associated with a transaction. The sensor data represents one or more environmental observations of the location. The approach also involves generating a capsule of the one or more environmental observations and tagging the capsule with the time of the transaction. The approach further involves cryptographically signing the capsule and providing the cryptographically signed capsule as a proof of location.

### RELATED APPLICATION

This application claims priority from U.S. Provisional Application Ser. No. 63/295,107, entitled “Method, Apparatus, And System for Providing Transaction Proof Of Location,” filed on Dec. 30, 2021, the contents of which are hereby incorporated herein in its entirety by this reference.

### BACKGROUND

Service providers face significant technical challenges with respect to ensuring the legitimacy of transactions and providing proof of this legitimacy. One factor in providing such proof is confirming the locations of parties to a transaction at a time and location of the transaction. Accordingly, the technical challenges faced by service providers can relate more specifically to providing proof of location for participants of a transaction.

### Some Example Embodiments

Therefore, there is a need for transaction proof of location.

According to one embodiment, a method comprises collecting sensor data from one or more sensors of a device at a time, a location, or a combination thereof associated with a transaction. The sensor data represents one or more environmental observations of the location. The method also comprises generating a capsule of the one or more environmental observations and tagging the capsule with the time of the transaction. The method further comprises cryptographically signing the capsule and providing the cryptographically signed capsule as a proof of location.

According to another embodiment, an apparatus comprises at least one processor, and at least one memory including computer program code for one or more computer programs, the at least one memory and the computer program code configured to, with the at least one processor, cause, at least in part, the apparatus to collect sensor data from one or more sensors of a device at a time, a location, or a combination thereof associated with a transaction. The sensor data represents one or more environmental observations of the location. The apparatus is also caused to generate a capsule of the one or more environmental observations and tag the capsule with the time of the transaction. The apparatus is further caused to cryptographically sign the capsule and provide the cryptographically signed capsule as a proof of location.

According to another embodiment, a non-transitory computer-readable storage medium carries one or more sequences of one or more instructions which, when executed by one or more processors, cause, at least in part, an apparatus to collect sensor data from one or more sensors of a device at a time, a location, or a combination thereof associated with a transaction. The sensor data represents one or more environmental observations of the location. The apparatus is also caused to generate a capsule of the one or more environmental observations and tag the capsule with the time of the transaction. The apparatus is further caused to cryptographically sign the capsule and provide the cryptographically signed capsule as a proof of location.

In addition, for various example embodiments described herein, the following is applicable: a computer program product may be provided. For example, a computer program product comprising instructions which, when the program is executed by a computer, cause the computer to perform any one or any combination of methods (or processes) disclosed.

According to another embodiment, an apparatus comprises means for collecting sensor data from one or more sensors of a device at a time, a location, or a combination thereof associated with a transaction. The sensor data represents one or more environmental observations of the location. The apparatus also comprises means for generating a capsule of the one or more environmental observations and tagging the capsule with the time of the transaction. The apparatus further comprises means for cryptographically signing the capsule and providing the cryptographically signed capsule as a proof of location.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing transaction proof of location, according to one embodiment;

FIG. 2 is a diagram of the components of trusted location platform or client capable of providing transaction proof of location, according to one embodiment;

FIG. 3 is a flowchart of a process for providing transaction proof of location, according to one embodiment;

FIG. 4 is diagram illustrating an example of creating a cryptographically signed capsule, according to one embodiment;

FIG. 5 is a diagram illustrating an example of creating a multiparty agreement using cryptographically signed capsules, according to one embodiment;

FIG. 6 is a diagram illustrating an example of verifying proof of location from a cryptographically signed capsule, according to one embodiment;

FIG. 7 is a diagram of a geographic database, according to one embodiment;

FIG. 8 is a diagram of hardware that can be used to implement an embodiment;

FIG. 9 is a diagram of a chip set that can be used to implement an embodiment; and

FIG. 10 is a diagram of a mobile terminal (e.g., handset or vehicle or part thereof) that can be used to implement an embodiment.

### DESCRIPTION OF SOME EMBODIMENTS

Examples of a method, apparatus, and computer program for providing transaction proof of location are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

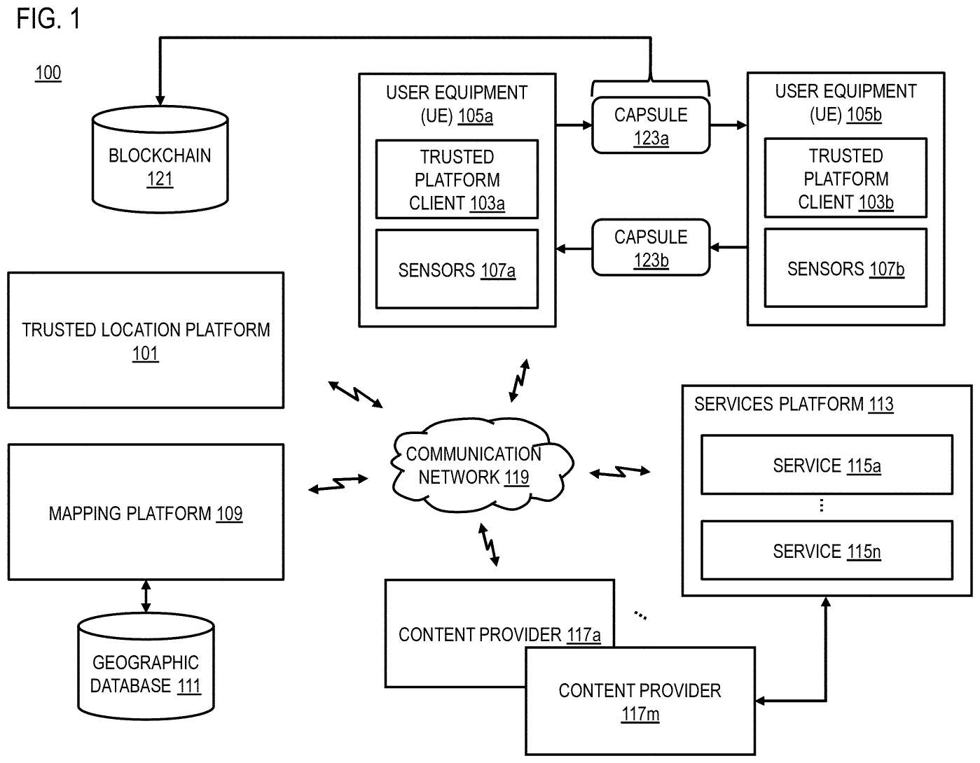

FIG. 1 is a diagram of a system 100 capable of providing transaction proof of location, according to one embodiment. The system 100, for instance, includes a trusted location platform 101 (server-side component) or trusted location clients 103a and 103b (e.g., also collectively referred to as trusted location clients 103 that are executing on local or edge device components such as but not limited to user equipment (UE) devices 105a and 105b— also collectively referred to as UEs 105) to perform functions related to using environmental observations indicated in sensor data collected from sensors (e.g., sensors 107a and 107b— also collectively referred to as sensors 107) of a mobile device (e.g., UE 105) to provide proof that the device is or was located at a stated location. This proof of location can be used a variety of transactions, applications, and/or services such as those provided by a mapping platform 109 (e.g., providing location based services based in combination with a geographic database 111), services platform 113, one or more services 115a-115n (e.g., services depending or otherwise using proof of location data; also collectively referred to as services 115) of the services platform 113, content providers 117a-117m (also collectively referred to as content providers 117) accessible over a communication network 119. Various embodiments for providing transaction proof of location are illustrated below in more detail.

In one embodiment, the system 100 generates the transaction proof of location as a Trusted Location. For example, utilizing the full suite of positioning technologies (e.g., provided over the communication network 119 by the mapping platform 109 with connectivity to digital map data of the geographic database 111), tracking solutions, blockchain services (e.g., for recording trusted locations and/or other proof of location on a blockchain 121 (or any other equivalent database of transaction records), privacy protection solutions, and additional location intelligence products, Trusted Location (e.g., provided by the trusted location platform 101) provides an auditable proof of where something (e.g., a device, person, object, etc.) is at any given time. The various embodiments of the trusted location platform 101 validate travel path, the arrival time, and exact location of a delivery, providing an indisputable proof of location to help resolve discrepancies, improve system integrity, support regulatory compliance, and inform loss/delay/fraud claims.

Advantages of the trusted location platform include:
reassurance for high-value time-sensitive transports of goods, services, etc.,
auditable log for third party payer (e.g., log of payments or transactions occurring at one or more trusted locations), and
the trusted location platform 101 as a neutral third party will not retain knowledge of what is transported to where, and/or other details of the transactions.

By way of example, the trusted location of the system 100 supports applications such as but not limited to:

(1) Location verification. A timestamped location record at the start or the end of a journey establishes proof of origin or destination. ID verification of the sender, receiver, and transporter is also available as an optional add-on safeguard measure.

(2) Route validation. A timestamped travel record throughout the journey provides reassurance of the travel path, especially when a designated path is mandated, no-travel zone needs to be enforced, and unplanned stops require scrutiny.

(3) Audit support. Recreation of the locations and paths from environment observations, including timestamps and associated identification details, if applicable.

(4) Smart contract. A trigger to initiate the execution of a smart contract upon task completion, such as a successful delivery or payment to a toll-road booth.

In one embodiment, trusted location can be used alone or in combination with tracking. Tracking, for instance, is a platform (e.g., via the mapping platform 109, services platform 113, or equivalent) that provides real-time and historical visibility on the location and status of mobile assets. The source of tracking data is from sources such as but not limited to hardware trackers and mobile applications (e.g., executing on UEs 105).
Hardware trackers—The trackers are provided by a range of providers offering tailored device capabilities and connectivity, use Mapping Platform Positioning to improve battery life and reliability, ensuring end-to-end visibility: indoors and outdoors, worldwide. Mapping Platform Tracking can also work with third party trackers not initially in its ecosystem. These third party trackers can be added on a case-by-case basis and may not be valid for all trackers (e.g., depending on hardware/software compatibility).
Application: Mapping Platform Tracking can also work with mobile applications that can be installed on mobile phones and tablets (e.g., UEs 105).

Depending on the use case, telemetry data from the different sources is used by the trusted location platform 101 and/or mapping platform 109 to optimize for the asset's utilization or performance.

By way of example, two example use cases covered by Mapping Platform Tracking are (1) the tracking of reusable/returnable or field or industrial assets via an Industry Product “Asset Tracking” and optimization of Estimated Time of Arrival (ETA), and (2) visibility into multi-modal/inter-modal shipments of high value and time critical goods via a “Shipment Visibility” industry product that enables verification of the location of a shipment of goods from origin to destination over multiple modes of transport.

In yet another embodiment, trusted location can be used in combination with mapping platform positioning (e.g., provided by the mapping platform 109). Mapping Platform Positioning, for instance, is a comprehensive suite of cloud-based services and software development kits (SDKs) to locate devices (e.g., UEs 105, tracking devices, etc.) with high precision using satellite, cellular and Wi-Fi signals, as well as sensors (e.g., sensors 107), both outdoors and indoors. In outdoor environments, using satellite systems, Mapping Platform Positioning provides hyper precise, sub-meter level location accuracy (HD GNSS). In urban environments and indoors when satellite signal is compromised or not available, Mapping Platform Positioning utilizes a database of constantly updated mobile Cell IDs and Wi-Fi access point measurements to locate devices. For private environments, where crowdsourcing is not optimal, the mapping platform 109 also provides radio mapping tools leveraging cellular and Wi-Fi signals.

Mapping Platform Positioning (e.g., provided by the mapping platform 109) is comprised components such as but not limited to:
Network Positioning—a set of device side implementation (SDK), a RESTful API and on premises solutions to provide accurate positioning of devices when satellite signal is compromised or not available such as in urban environments or indoors. In one embodiment, it leverages a global database of over 93 million cell-IDs (GSM, WCDMA, TD-SCDMA, TD-SCDMA, LTE, CDMA) and 3.8 billion Wi-Fi access points that a mobile client (e.g., UE 105) can detect to obtain a geographic position in 3D, providing continuous location coverage.
GNSS Positioning—A GNSS Positioning optimizes satellite positioning performance by reducing the time to first fix (TTFF) of devices using a satellite-based positioning system (GNSS receiver), in order to increase their sensitivity and reliability. In online mode, the system 100's A-GNSS (Assisted GNSS) Positioning also includes the real-time status of satellites thereby improving the integrity of the position calculation. In offline mode, the TTFF is greatly reduced as the assistance data is dynamically generated on the device based on previously received satellite data received from the Mapping Platform 109's Global Assistance Data Delivery Infrastructure. Power consumption is significantly reduced using a condensed local database of cell towers and Wi-Fi access points allowing a user to quickly find the best possible reference location in the offline mode.
HD GNSS Positioning is a cloud streaming service that provides sub-meter level positioning accuracy for mobile devices, improving accuracy by 3-4 times over regular satellite positioning. The service removes Iono/Tropospheric delays by merging GNSS signals on several frequencies and applies orbit/clock corrections from the world-wide network of reference stations. Corrections are delivered in SSR format, requiring very low bandwidth. HD GNSS is designed to work in an open sky environment and requires a raw GNSS data stream with continuous connectivity.

In one embodiment, the various components described above comprise sensor observations of the location of the UE 105 or associated person, object, etc. within a geographic environment. A capsule of the observations is made by each party in the transaction (e.g., capsule 123a by UE 105a and capsule 123b by UE 105b— also collectively referred to as capsules 123) and tagged with the time of the transaction. Each party's capsule 123 is then cryptographically signed by the private key of a PKI key pair associated with the party. Each party then signs the other party's capsule 123. This can all be done as an automated process, only requiring the user's input to sign their capsules 123 and that of the other parties. The output is a multiparty agreement that a transaction took place with a set of tamper evident environmental observations which can be used to reconstruct the location of the transaction (e.g., representing the proof of location).

These capsules 123 can be kept locally (e.g., at each participating UE 105), as well as transmitted to a transaction log (e.g., can be maintained in a distributed manner through blockchain 121, or as a centralized neutral party service as a database or distributed blockchain ledger) as proof of location (e.g., a trusted location).

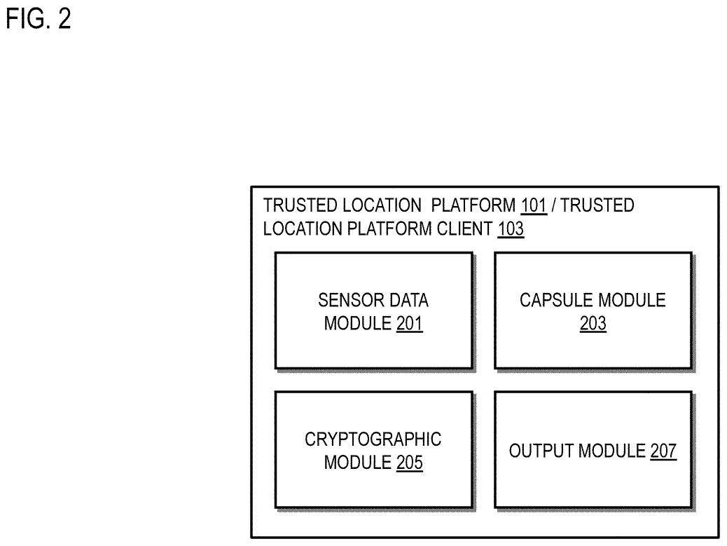

In one embodiment, the trusted location platform 101 and/or trusted location client 103 alone or in combination perform functions related to providing transaction proof of location according to the various embodiments described herein. FIG. 2 is a diagram of the components of trusted location platform 101 or client 103 capable of providing transaction proof of location, according to one embodiment. As shown in the example of FIG. 2, the trusted location platform 101 and/or the trusted location client 103 includes one or more components. It is contemplated that the functions of the components of the trusted location platform 101 and/or the trusted location client 103 may be combined or performed by other components of equivalent functionality. In the illustrated example, the trusted location platform 101 and/or the trusted location client 103 include a sensor data module 201 for collecting sensor-based environmental observations, a capsule module 203 for generating a capsule of the environment observations, a cryptographic module 205 for cryptographically signing the capsules, and an output module 207. The above presented modules and components of the trusted location platform 101 and/or the trusted location client 103 can be implemented in hardware, firmware, software, circuitry, or a combination thereof. Though depicted as separate entities in FIG. 1, it is contemplated that the trusted location platform 101 and/or the trusted location client 103 may be implemented as a module of any of the components of the system (e.g., a component of the services platform 113, services 115, content providers 117, mapping platform 109, UEs 105, applications executing on the UEs 105, and/or the like). In another embodiment, one or more of the modules 201-207 of trusted location platform 101 and/or the trusted location client 103 may be implemented as a cloud-based service, local service, native application, or combination thereof. The functions of the trusted location platform 101, the trusted location client 103, and/or their modules 201-207 are discussed with respect to the figures below.

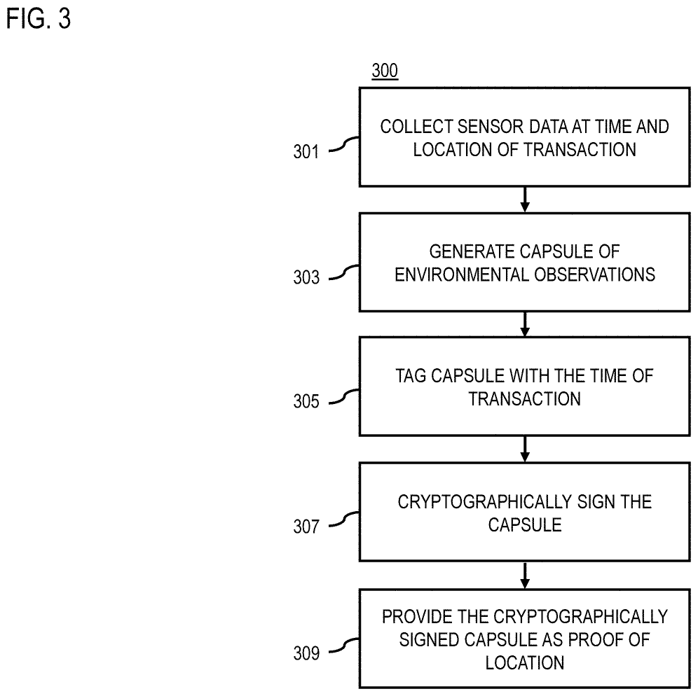

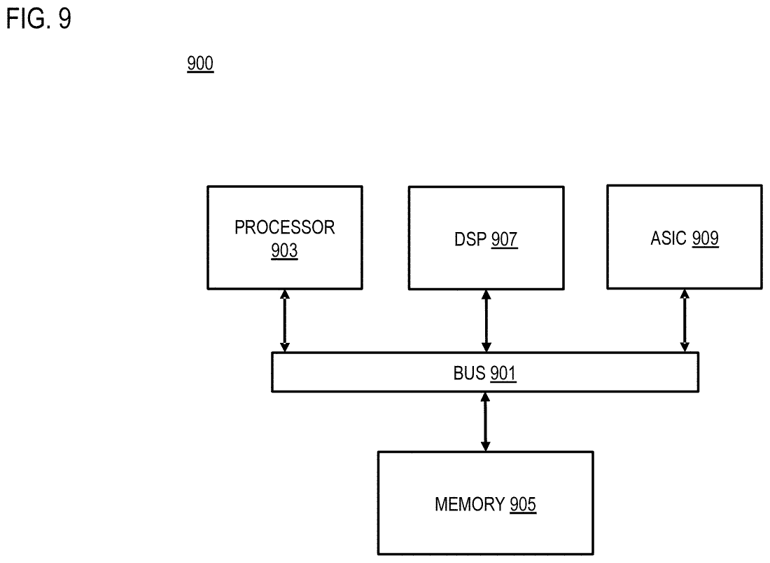

FIG. 3 is a flowchart of a process 300 for providing transaction proof of location, according to one embodiment. In various embodiments, the trusted location platform, the trusted location client, and/or any of their modules may perform one or more portions of the process 300 and may be implemented in, for instance, a chip set including a processor and a memory as shown in FIG. 9. As such, the trusted location platform and/or the trusted location client can provide means and/or include circuitry for accomplishing various parts of the process 300, as well as means for accomplishing embodiments of other processes described herein in conjunction with other components of the system. Although the process 300 is illustrated and described as a sequence of steps, it is contemplated that various embodiments of the process 300 may be performed in any order or combination and need not include all of the illustrated steps.

In summary, in step 301, the sensor data module collects sensor data from one or more sensors of a device at a time, a location, or a combination thereof associated with a transaction, wherein the sensor data represent one or more environmental observations of the location. In one embodiment, the one or more environmental observations include at least one of: a geolocation of the device; a mobile network carrier to which the device is connected; a signal strength of the mobile network carrier; a base station list of one or more base stations, one or more base station identity codes, one or more base station frequencies, or a combination thereof detected by the device; a wireless network list comprising one or more wireless networks to which the device is connected or that can be detected by the wireless device, a wireless signal strength of the one or more wireless networks, a wireless frequency of the one or more wireless networks, or a combination thereof; or a barometric pressure measure by the device.

In some cases, the radio environment of a location may be weak or sparse. In this case, Areas with few position-able, observable radio signals have a few ways to increase the viability of the solution. These methods include but are not limited to setting up a local WiFi network which can provide an agreeable environmental factor (e.g., produce a signal that can be observed and recorded as a local radio observation to generate a capsule 123).

There could also be the introduction of a third-party point of presence hardware, which either broadcasts a verifiable signal, or provides near-field communication (NFC) negotiated tokens, signed by the third party, to be encapsulated in the transaction capsules 123, to be known as trusted tokens. A party would incorporate this into their transaction capsule and the trusted token would be verifiable by containing the third party's signed token.

In step 303, the capsule module 203 generates a capsule 123 of the one or more environmental observations. In one embodiment, a capsule 123 can include or otherwise be derived from details of the location radio observations (e.g., observations made by sensors 107 as described in step 301). For example, a party to the agreement/transaction can provide a list of the available WiFi access points (or other equivalent transmitting devices) and notes their characteristics (e.g., SSID, frequency, power level, etc.) and observation timestamp. By way of example, information of local access points is available on mobile devices (e.g., UEs 105) through ds the iOS Hotspot helper API capability on iOS devices and the Android ScanResult through WifiManager on Android devices.

Next, the party (e.g., via UE 105) uses the platform location services to retrieve their (GPS assisted) location with the provided error radius.

The information for the connected serving cell tower can also be recorded including the attributes such as but not limited to: MCC, MNC, LAC, ARFCN, and BSIC. It is noted that the attributes of the cell tower are provided by way of illustration and not as limitation. The list of attributes will also vary per technology type used for the cell tower.

In one embodiment, the local radio observations can be encoded into a structured text file or equivalent (e.g., referred to as the capsule 123 or signature).

In step 305, the capsule module 203 tags the capsule 123 with the time of the transaction (e.g., based on the observation timestamp).

In step 307, the cryptographic module 205 cryptographically signs the capsule 123.

In step 309, the output module 207 provides the cryptographically signed capsule 123 as a proof of location or output for use by other components of the system 100 (e.g., services platform 113, services 115, content providers 117, UEs 105, etc.). In yet another embodiment, the output module can record the cryptographically signed capsule on the blockchain 121 or other transaction database or log.

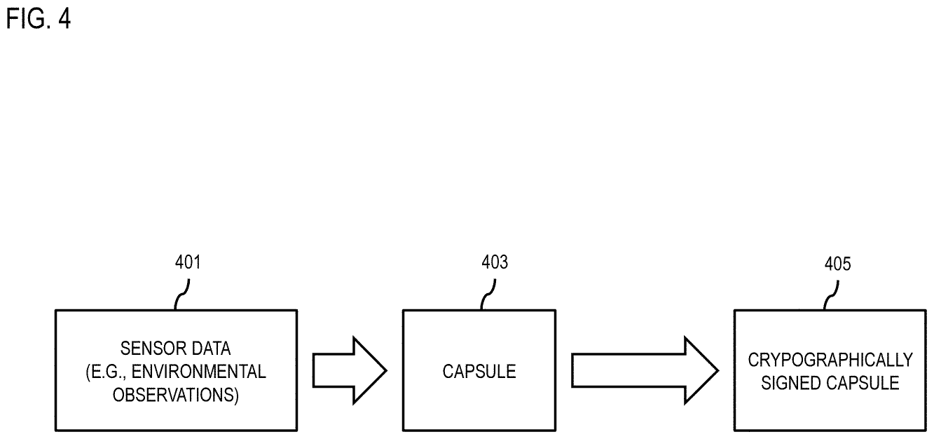

FIG. 4 is diagram illustrating an example of creating a cryptographically signed capsule, according to one embodiment. In this example, sensor data 401 is collected from one or more sensors 107 of UEs 105 associated with one or more parties, objects, etc. that is subject to location verification. The sensor data 401, for instance, represents environmental observations at the location (e.g., local radio environment comprising signals from nearby wireless base stations, network access points, and/or other transmitting devices). The features or attributes of the sensor data 401 are then used to create a capsule 403 (e.g., representing a digest of the sensor data 401). The capsule 401 is then cryptographically signed (e.g., via a public/private key infrastructure or equivalent) to generate a cryptographically signed capsule 405.

In one embodiment (e.g., in a multiparty transaction or agreement use case), once each party has prepared and signed their own capsules 123, they may choose to check the capsules 123 of the other parties. This can involve parsing radio environment observation associated with the other party's capsule 123 and attempting to rectify it with their own radio environment (e.g., to determine whether the same radio environment is represented in the capsule 123 of the other party). In one embodiment, tolerance can be made for observations which are different from the verifiers (e.g., by creating criteria or acceptable threshold ranges for radio observations—such as presence of the top three strongest radio signatures). If the capsules are deemed to deviate too much, the party may reject the capsule 123 and ask for a new one. Tolerances can be widened for known problem areas, such as dense urban areas with high radio signal reflectivity.

In one embodiment, capsules 123 without all parties' signatures or otherwise do not meet tolerance levels can be marked as invalid.

In other words, the cryptographically signed capsule 123 is exchanged with another device (e.g., another UE 105 associated with another party to the transaction, a verification server/device, etc.) using shortrange wireless communication (e.g., Bluetooth, NFC, WiFi, etc.). By way of example, the output module 207 can periodically scan for the another device. In this case, the cryptographically signed capsule 123 is exchanged with the other device based on the scanning.

In one embodiment, the cryptographic module 205 can receive another cryptographically signed capsule 123 from another device associated with the transaction. The another cryptographically signed capsule 123 is generated from other sensor data collected from the another device and is cryptographically signed by the another device. Then, the device (e.g., a first party to the multiparty agreement/transaction) cryptographically signs the another cryptographically signed capsule of the another device (e.g., a second party to the multiparty agreement/transaction) as part of a multiparty agreement. In addition, the another device (e.g., second party) cryptographically signs the cryptographically signed capsule 123 of the device (e.g., first party) as part of the multiparty agreement. The output module 207 can provide the multiparty agreement as proof of the transaction or a location of the transaction.

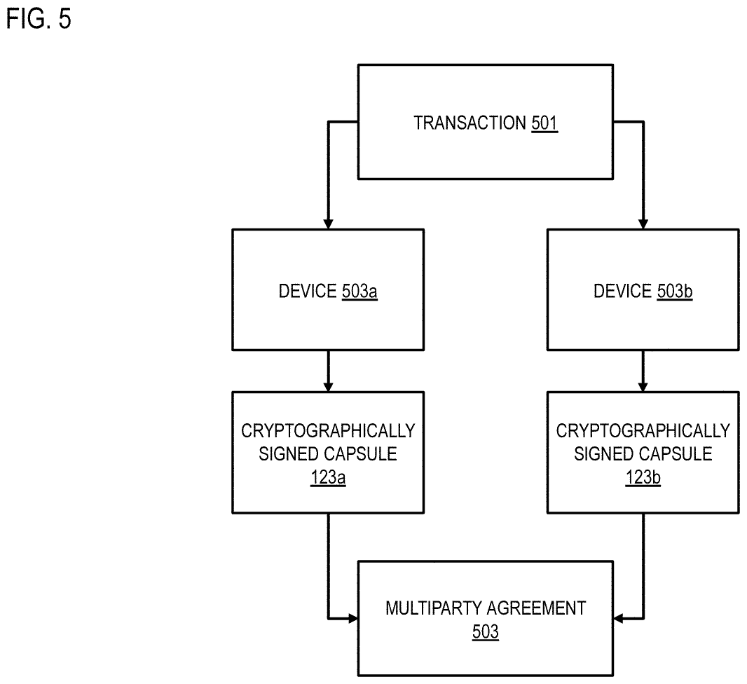

FIG. 5 is a diagram illustrating an example of creating a multiparty agreement using cryptographically signed capsules, according to one embodiment. In this example, two devices 503a and 503b (e.g., UEs 105) are entering into a multiparty transaction 501 at a given location and want proof of location to verify that each device 503a and 503b was present at the location of the transaction 501. Each device 503a and 503b generates respective cryptographically signed capsules 123a and 123b as described in the various embodiments above. The cryptographically signed capsules 123a and 123b are exchanged, verified, and cross-signed to create a multiparty agreement 503.

In one embodiment, the cryptographic module 205 can decrypt the one or more environmental observations from the cryptographically signed capsule to verify the proof of location. For example, if an audit or other verification of the transaction is required, the capsule's data can be projected onto a Geographic Information System (GIS) by each of the available radio mapping positioning inputs encapsulated (e.g., cellular, WiFi, GPS, etc.). A successful audit or verification will use the parties' public keys to verify signatures on the capsules 123 as well as look for agreement on each of the radio signal capsules (within a configured tolerance).

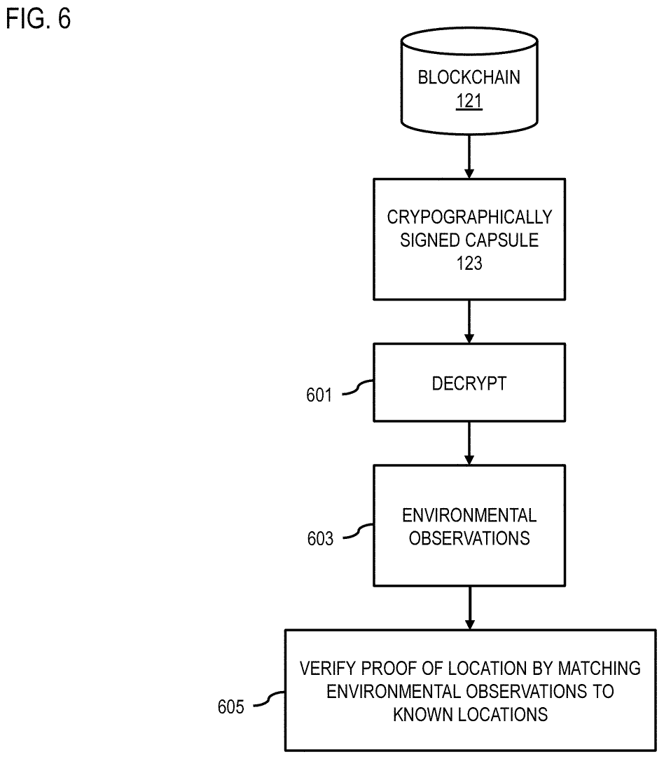

FIG. 6 is a diagram illustrating an example of verifying proof of location from a cryptographically signed capsule 123, according to one embodiment. In this example, a cryptographically signed capsule 123 can be retrieved from a blockchain 121 or any other database or transaction log for verification. At process 601, the retrieved cryptographically signed capsule 123 is decrypted to determine environmental observations 603 (e.g., local radio observations) encoded in the capsule 123. At process 605, the system 100 then verifies the proof of location (e.g., associated with the capsule 123) by matching the environmental observations 603 against to the environment associated with location associated with the proof, a location association associated with a corresponding cryptographically signed capsule 123 from another party of the transaction, or other known locations.

In one embodiment, the cryptographically signed capsule 123 is integrated with an identity token provided by an identity verification system. In addition or alternatively, third party verification can also enable the absence of the receiving party by providing a proxy presence for the receiver. In this scenario, the receiver's device (e.g., an Internet of Things (IoT) device such as but not limited to a doorbell, security camera, credit card reader, etc.) could have a near field communication (NFC), Bluetooth, or equivalent enabled third party point of presence to negotiate a trusted token. Third party proxies could add additional verification by triggering image capture, video/audio capture to have further proof of presence.

In one embodiment, as in the multiparty case (e.g., two-party case) described previously, a single party may collect local radio environment observations and package them in a signed capsule 123 as a way to provide a proof of location. In this case, an additional measure can be taken to prevent spoofing of the location. The system 100 can used methods such as but not limited to the following to mitigate any false location capsule risks:
Local hardware device signs over a location sensitive channel, such as NFC. The local device signs the capsule with a reading of the requester's radio signal or a picture of the requestor in the case of a video doorbell or other remote camera device.
Location sensitive server, such as one on a 5G paired MEC server, receives a signing request from a single-party capsule author. The server signs the capsule with a reading of the requester's radio signal.

The single-party case can present additional vulnerabilities, such as sign-by-proxy to fake the location of the requesting agent. This could provide a remote attack vector via compromised cellphones, or surreptitiously placed relay radios. These cases may want to leverage attaching visual records to the location capsule to further mitigate risks.

In one embodiment, the mapping platform 109 alone or in combination with the trusted location platform 101 provide core competencies with respect to providing transaction proof of location and/or other related location-based services in the supply chain market or any other equivalent industry. Examples of such location-based services are provided below by way of illustration and not as limitations.

The mapping platform 109 (and/or services platform 113) uses various technologies to help solve location-related business problems in a number of markets; including but not limited Fleet Management, Supply Chain Optimization, Transportation and Logistics, Public Sector, Urban Mobility, Automotive, Connected Driving, Consumer Engagement, Insurance, Media, Retail, Telecommunications, and more. Below are illustrative but not exclusive example services and/or functions of the mapping platform 109/services platform 113 that help solve those problems. Applications of the various embodiments of the trusted location platform include but are not limited to:
A. Visibility: See, understand, and control supply chain assets from start to finish, down to the smallest item.
B. Optimize transport and sourcing by knowing where your objects or shipments are, at any location or time.
C. Meet the moment: Deliver on customers' time, in their now. Accelerate delivery and elevate the customer experience.
D. Understand costs and supplier performance to get the edge in negotiations.
E. Interoperability with existing tools to create additional value, not redo tried and tested systems.

Other example applications include but are not limited to:
A. Supply Chain complexity driven by technology and business challenges, e.g., volatility, customer centricity, e-commerce & omni-channel, global business networks.
B. Visibility: first step in any optimization is understanding the status quo, only small percentage of companies currently can do that.
C. Sustainability: Reducing CO₂ emissions, sourcing sustainable materials, new regulations, and meeting corporate sustainability goals.
D. Technologies: IoT, (indoor) positioning and tracking, 5G, cloud computing, big data analytics.
E. Covid disruption: Quickly mitigating factory closures, and raw material shortages.

Examples of how the mapping platform 109 and/or trusted location platform 101 can provide such applications in the supply chain industry include but are not limited to:
A. The mapping platform 109 and/or trusted location platform 101 seamlessly connects from the warehouse to the yard to the road so that supply chain managers can have end-to-end visibility into both breadth (number of assets) and depth (reliability and continuity of tracking).
B. The mapping platform 109 and/or trusted location platform 101's connected, traceable supply chain capabilities allow customers to get inputs about their supply chain from one trustworthy source instead of separate systems. By placing sensors 107 in everything, creating networks everywhere, automating anything, and analyzing everything, we enable customers to achieve precise visibility into each phase of the process, allowing for accelerated time to delivery and less material and time waste. As a result, customers can have a complete location/time-stamp record of their supply chain instead of relying on different inputs from multiple systems. This allows them to optimize their assets and minimize disruptions before they become critical.
C. The mapping platform 109 and/or trusted location platform 101's capabilities allow customers to regularly predict and create class-leading reliable ETAs, allowing customers to negotiate supplier and carrier prices better, and estimate accurate mileage for journeys.
D. The mapping platform 109 and/or trusted location platform 101 has an industrial-style map with more than 100 truck-centric attributes, providing important data that enable the creation of more specific plans than industry standard systems in the market, improving Plan vs. Actual forecast.
E. The mapping platform 109 and/or trusted location platform 191 are enterprise-ready with rich, accurate maps that provide up-to-date data and can easily be integrated into existing systems and business processes. This allows customers to achieve a global scale for their operations in a fast, reliable, and cost-effective manner.

The mapping platform 109 and/or trusted location platform 101 provide access to content and software to support the applications and/or functions described above. Examples include but are not limited to:
Support implementation of a Mobile SDK. This enables the provision of online and offline access to mapping platform map content and visualization, routing, search, and geocoding. This content includes location data, map tiles, points of interest, building footprint data, hydrology, and the ability to preload the content and services onto a device for utilization when there are no available networks. The data can be preloaded.
Support implementation of precision enhanced GPS positioning via A-GNSS and HD-GNSS positioning services. The mapping platform 109 can provide sub meter location precision when the device (e.g., UE 105) is connected to the network 119 and able to access the mapping platform cloud.
Support implementation of offline network Positioning. In environments where satellite signal is compromised or not available, the Mapping Platform Positioning utilizes a database of constantly updated mobile Cell IDs and Wi-Fi access point measurements, which can be pre-loaded to the device (e.g., UE 105). For private environments, where crowdsourcing is not optimal, the Mapping Platform Positioning also provides radio mapping tools to create deployable radio maps from Wi-Fi signals.
Support implementation of the Mapping Platform Tracking. Helping solve supply chain visibility.
Support implementation of Trusted Location and Authentication. The solution validates travel path, the arrival time, and exact location of a delivery, providing an indisputable proof to help resolve discrepancies, improve system integrity, support regulatory compliance, and inform loss/delay/fraud claims.

In one embodiment, these functions can be implemented via the following:

AN SDK—This includes a set of programming interfaces for native development that allows access to a rich portfolio of location features including mapping, routing, geocoding, search, and navigation which can be deployed in an offline (pre-loaded) and online mode on an individual mobile device (e.g., UE 105). The SDK can be made available through a plugin (e.g., an Android Tactical Assault Kit (ATAK) plugin or equivalent), and the data can be preloaded on edge devices via, e.g., the Nett Warrior EUD, IVAS system and the MMC. The MMC will act as an extended storage location for additional map data for the edge devices. Map data can include but is not limited to:
Worldwide vector maps, small in data size, minimize latency and provide fast response times, while still scaling to a high degree of fidelity.
Various map styles and schemes: normal, terrain, pedestrian, transit, traffic, navigation and more.
Offline capability for mapping, geocoding and search, routing, and navigation
Points of interest, building footprint data, hydrography.

MAPS API FOR JAVA SCRIPT—The Maps API for JavaScript gives access to a variety of location features so that customers can easily integrate mapping, geocoder, traffic, routing, and fleet telematics capabilities into applications. For example, a Maps API for JavaScript is designed not only for desktop web development but also for mobile HTML5 browsers. It enables location-based internet applications with feature-rich and customizable digital maps (e.g., provided by the mapping platform 109 and geographic database 111), while taking advantage of the simple and feasible JavaScript structure.

GEOCODING & SEARCH API—The Geocoding and Search API is a RESTful service leveraging the mapping platform, which provides a portfolio of geocoding and search functionality for addresses and POIs/Places.

FLEET TELEMATICS, GEOFENCING—For example, geofencing enables polygons to be created and georeferenced to the map to monitor asset position relative to geofence boundaries and enable alerts for ingress/egress events in/out of a defined geofence.

In one embodiment, the various embodiments for providing proof of location can be implemented in a UE 105 (e.g., a mobile phone client) as follows:
1. Integrate with a Third-Party Identity Verification system (e.g., operated by a credit card provider or other financial institution)
   a. Allows a user to verify their identity using the third-party's services and retain the identity token received.
2. Passively track the following information:
   a. The phone's GPS Coordinates
   b. The Mobile network carrier to which the phone is actively connected, and the signal strength (RSSI, RSRQ if available)
   c. The audible base station identity codes and frequencies of cell towers the phone can hear but is not connected to.
   d. Any WiFi network to which the phone is connected (SSID, MAC if available)
      i. The signal strength of the WiFi connection
      ii. The frequency of the connection (2.4 Ghz, 5 ghz, etc.)
   e. The barometric pressure as measured by the phone
3. Build a Bluetooth Service which listens for “signature requests” from other phones with the client installed. This service can receive the information from (1) and (2) contained in a message with a cryptographic signature also present. The service can verify that all the values agree with what the serving phone can see and send back the packet with a cryptographic signature.
4. The app can periodically scan for available Bluetooth services with which to exchange location verification. Upon finding one, it should send a signed packet of the information in (1) and (2) and expect the service to verify and send back a signed packet.

In one embodiment, the various embodiments for providing proof of location can be integrated with a blockchain (e.g., blockchain 121) as follows:
1. Clients 103 can log the results of all location packets onto the blockchain 121 (e.g., associated with the mapping platform 109) at the end of every “signature request” exchange. The signed packets and the agreement status should be noted in the added block.
2. Clients 103 can communicate with the blockchain service via exposed service endpoints and with platform credentials (e.g., obtained from the mapping platform 109 or other equivalent component).
3. Clients 103 can note the block ID received from the blockchain interaction to use for later lookup and audit purposes.

In one embodiment, verification of location can be implemented as follows:
1. Confidence in the claimed position can be based by an accumulated confidence score. Higher fidelity signals and known fixed point communications will have higher confidence. Bluetooth signals from known fixed locations should receive the highest confidence.
2. Separately perform positioning triangulation on each of the signal classes present in the location packet. In the order of accuracy, compare the claimed position to the claimed position of each class. One example order of comparison is Bluetooth LE, Bluetooth, WiFi, Cellular Radio.
3. For each signal class which agrees with the claimed position, increase the confidence in the claimed position. Higher weight can be given to more accurate signals (e.g., in the example order listed above).
4. If pieces of the body of evidence disagree with the claimed position, the confidence can be lowered by an in-kind amount.
5. For confidence scores above a threshold, the result can be marked as a success (e.g., successful proof of location). This will likely be a score that is based on at least two agreeing sources without any disagreeing sources.
6. If the confidence score is reduced below a determined threshold (e.g., 0 in an additive model), the token is to be marked as failed, and the result is to be signed by the assessing party and added to the blockchain 121.

Returning to FIG. 1, as shown, the system 100 includes the mapping platform 109 and/or trusted location platform 101 for providing transaction proof of location. In one embodiment, the mapping platform 109 and/or trusted location platform 101 has connectivity over the communication network 119 to services platform 113 that provides one or more services 115 that can use the transaction proof of location for downstream functions. By way of example, the services 115 may be third party services and include but is not limited to mapping services, navigation services, travel planning services, notification services, social networking services, content (e.g., audio, video, images, etc.) provisioning services, application services, storage services, contextual information determination services, location-based services, information-based services (e.g., weather, news, etc.), etc. In one embodiment, the services 115 use the output of the mapping platform 109 and/or trusted location platform 101 (e.g., transaction proof of location) to provide services such as navigation, mapping, other location-based services, etc. to client devices (e.g., UEs 105).

In one embodiment, the mapping platform 109 and/or trusted location platform 101 may be a platform with multiple interconnected components. The mapping platform 109 and/or trusted location platform 101 may include multiple servers, intelligent networking devices, computing devices, components, and corresponding software for determining map feature identification confidence levels for a given user according to the various embodiments described herein. In addition, it is noted that the mapping platform 109 and/or trusted location platform 101 may be a separate entity of the system of FIG. 1, a part of one or more services 115, a part of the services platform 113, or included within components of the UEs 105.

In one embodiment, content providers 117 may provide content or data (e.g., including sensor data such as image data, probe data, related geographic data, environmental observations, etc.) to the geographic database 111, the mapping platform 109 and/or trusted location platform 101, trusted location client 103, the services platform 113, the services 115, the UEs 105, and/or the applications executing on the UEs 105. The content provided may be any type of content, such as sensor data, imagery, probe data, machine learning (inference) models, permutations matrices, map embeddings, map content, textual content, audio content, video content, image content, etc. In one embodiment, the content providers may provide content that may aid in providing a transaction proof of location according to the various embodiments described herein. In one embodiment, the content providers may also store content associated with the geographic database 111, mapping platform 109 and/or trusted location platform 101, trusted location client 104, services platform 113, services 115, and/or any other component of the system. In another embodiment, the content providers 117 may manage access to a central repository of data, and offer a consistent, standard interface to data, such as a repository of the geographic database 111.

In one embodiment, the UEs 105 may execute software applications to use a transaction proof of location or other data derived therefrom according to the embodiments described herein. By way of example, the applications may also be any type of application that is executable on the UEs 105, such as trusted location client 103, autonomous driving applications, routing applications, mapping applications, location-based service applications, navigation applications, device control applications, content provisioning services, camera/imaging application, media player applications, social networking applications, calendar applications, and the like. In one embodiment, the applications may act as a client for the mapping platform 109 and/or trusted location platform 101 and perform one or more functions associated with providing proof of location alone or in combination with the mapping platform 109 and/or trusted location platform 101.

By way of example, the UEs 105 are or can include any type of embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the UEs 105 can support any type of interface to the user (such as “wearable” circuitry, etc.). In one embodiment, the UEs 105 may be associated with or be a component of a vehicle or any other device.

In one embodiment, the UEs 105 are configured with various sensors 107 for generating or collecting environmental observation data, probe data, related geographic data, etc. In one embodiment, the sensed data represent sensor data associated with a geographic location or coordinates at which the sensor data was collected, and the polyline or polygonal representations of detected objects of interest derived therefrom to generate the digital map data of the geographic database. By way of example, the sensors 107 may include a global positioning sensor for gathering location data (e.g., GPS), IMUs, a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data (e.g., the camera sensors may automatically capture road sign information, images of road obstructions, etc. for analysis), an audio recorder for gathering audio data, velocity sensors mounted on steering wheels of the vehicles, switch sensors for determining whether one or more vehicle switches are engaged, and the like.

Other examples of sensors 107 of the UEs 105 may include light sensors, orientation sensors augmented with height sensors and acceleration sensor, tilt sensors to detect the degree of incline or decline (e.g., slope) along a path of travel, moisture sensors, pressure sensors, etc. In a further example embodiment, sensors about the perimeter of the UEs may detect the relative distance of the device or vehicle from a lane or roadway, the presence of other vehicles, pedestrians, traffic lights, potholes and any other objects, or a combination thereof. In one scenario, the sensors may detect weather data, traffic information, or a combination thereof. In one embodiment, the UEs 105 may include GPS or other satellite-based receivers to obtain geographic coordinates from positioning satellites for determining current location and time. Further, the location can be determined by visual odometry, triangulation systems such as A-GPS, Cell of Origin, or other location extrapolation technologies.

In one embodiment, the communication network 119 of system includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, 5G New Radio networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the mapping platform 109 and/or trusted location platform 101, trusted location client 103, services platform 113, services 115, UEs 105, and/or content providers 117 communicate with each other and other components of the system using well known, new or still developing protocols. In this context, a protocol includes a set of rules defining how the network nodes within the communication network interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

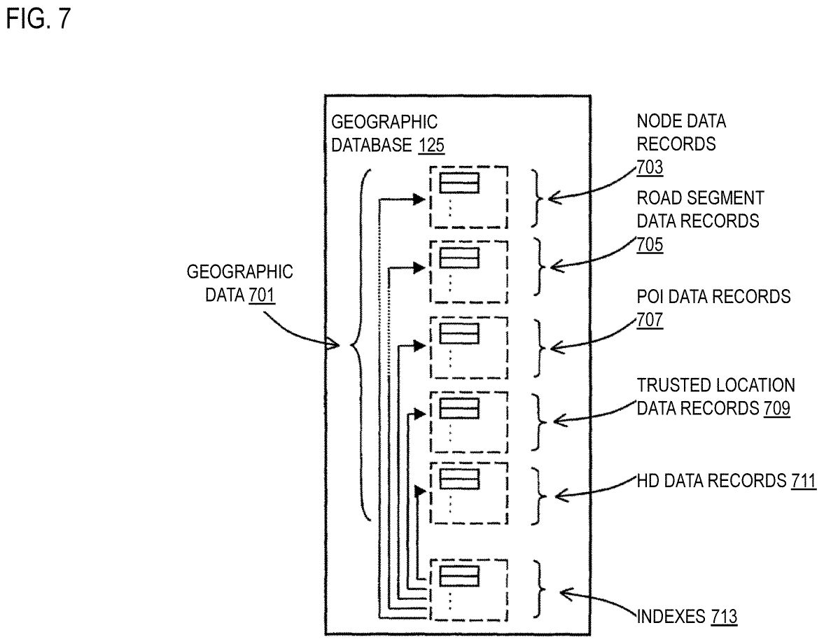

FIG. 7 is a diagram of a geographic database 111, according to one embodiment. In one embodiment, the geographic database 111 includes geographic data 701 used for (or configured to be compiled to be used for) mapping and/or navigation-related services, such as for providing map embedding analytics according to the embodiments described herein. For example, the map data records stored herein can be used to determine the semantic relationships among the map features, attributes, categories, etc. represented in the geographic data 701. In one embodiment, the geographic database 111 includes high definition (HD) mapping data that provide centimeter-level or better accuracy of map features. For example, the geographic database 111 can be based on Light Detection and Ranging (LiDAR) or equivalent technology to collect billions of 3D points and model road surfaces and other map features down to the number lanes and their widths. In one embodiment, the HD mapping data (e.g., HD data records 711) and/or other mapping data of the geographic database 111 capture and store details such as but not limited to road attributes and/or other features related to generating speed profile data. These details include but are not limited to road width, number of lanes, turn maneuver representations/guides, traffic lights, light timing/stats information, slope and curvature of the road, lane markings, roadside objects such as signposts, including what the signage denotes. By way of example, the HD mapping data enable highly automated vehicles to precisely localize themselves on the road.

In one embodiment, geographic features (e.g., two-dimensional or three-dimensional features) are represented using polylines and/or polygons (e.g., two-dimensional features) or polygon extrusions (e.g., three-dimensional features). In one embodiment, these polylines/polygons can also represent ground truth or reference features or objects (e.g., signs, road markings, lane lines, landmarks, etc.) used for visual odometry. For example, the polylines or polygons can correspond to the boundaries or edges of the respective geographic features. In the case of a building, a two-dimensional polygon can be used to represent a footprint of the building, and a three-dimensional polygon extrusion can be used to represent the three-dimensional surfaces of the building. Accordingly, the terms polygons and polygon extrusions as used herein can be used interchangeably.

In one embodiment, the following terminology applies to the representation of geographic features in the geographic database 111.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 111 follows certain conventions. For example, links do not cross themselves and do not cross each other except at a node. Also, there are no duplicated shape points, nodes, or links. Two links that connect each other have a common node. In the geographic database 111, overlapping geographic features are represented by overlapping polygons. When polygons overlap, the boundary of one polygon crosses the boundary of the other polygon. In the geographic database 111, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 111 includes node data records 703, road segment or link data records 705, POI data records 707, trusted location data records 709, HD mapping data records 711, and indexes 713, for example. More, fewer, or different data records can be provided. In one embodiment, additional data records (not shown) can include cartographic (“carto”) data records, routing data, and maneuver data. In one embodiment, the indexes 713 may improve the speed of data retrieval operations in the geographic database 111. In one embodiment, the indexes 713 may be used to quickly locate data without having to search every row in the geographic database 111 every time it is accessed. For example, in one embodiment, the indexes 713 can be a spatial index of the polygon points associated with stored feature polygons. In one or more embodiments, data of a data record may be attributes of another data record.

In exemplary embodiments, the road segment data records 705 are links or segments representing roads, streets, paths, or bicycle lanes, as can be used in the calculated route or recorded route information for determination of speed profile data. The node data records 703 are end points (for example, representing intersections or an end of a road) corresponding to the respective links or segments of the road segment data records 705. The road link data records 705 and the node data records 703 represent a road network, such as used by vehicles, cars, and/or other entities. Alternatively, the geographic database 111 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 111 can include data about the POIs and their respective locations in the POI data records 707. The geographic database 111 can also include data about road attributes (e.g., traffic lights, stop signs, yield signs, roundabouts, lane count, road width, lane width, etc.), places, such as cities, towns, or other communities, and other geographic features, such as bodies of water, mountain ranges, etc. Such place or feature data can be part of the POI data records 707 or can be associated with POIs or POI data records 707 (such as a data point used for displaying or representing a position of a city).

In one embodiment, the geographic database 111 can also include trusted location data records 709 for storing transaction proof of location, sensor data (environmental observations), multiparty agreements, capsules, and/or any other related data that is used or generated according to the embodiments described herein. By way of example, the bicycle lane deviation records 709 can be associated with one or more of the node records 703, road segment records 705, and/or POI data records 707 to associate the speed profile data records 709 with specific places, POIs, geographic areas, and/or other map features. In this way, the linearized data records 709 can also be associated with the characteristics or metadata of the corresponding records 703, 705, and/or 707.

In one embodiment, as discussed above, the HD mapping data records 711 model road surfaces and other map features to centimeter-level or better accuracy. The HD mapping data records 711 also include ground truth object models that provide the precise object geometry with polylines or polygonal boundaries, as well as rich attributes of the models. These rich attributes include, but are not limited to, object type, object location, lane traversal information, lane types, lane marking types, lane level speed limit information, and/or the like. In one embodiment, the HD mapping data records 711 are divided into spatial partitions of varying sizes to provide HD mapping data to end user devices with near real-time speed without overloading the available resources of the devices (e.g., computational, memory, bandwidth, etc. resources).

In one embodiment, the HD mapping data records 711 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the HD mapping data records 711.

In one embodiment, the HD mapping data records 711 also includes real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time data (e.g., including probe trajectories) also at centimeter-level accuracy. Other sensor data can include vehicle telemetry or operational data such as windshield wiper activation state, braking state, steering angle, accelerator position, and/or the like.

In one embodiment, the geographic database 111 can be maintained by the content provider in association with the mapping platform 109 and/or trusted location platform 101 (e.g., a map developer or service provider). The map developer can collect geographic data to generate and enhance the geographic database 111. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic database 111 can be a master geographic database 111 stored in a format that facilitates updating, maintenance, and development. For example, the master geographic database 111 or data in the master geographic database 111 can be in an Oracle spatial format or other format (e.g., capable of accommodating multiple/different map layers), such as for development or production purposes. The Oracle spatial format or development/production database can be compiled into a delivery format, such as a geographic data files (GDF) format. The data in the production and/or delivery formats can be compiled or further compiled to form geographic database 111 products or databases, which can be used in end user navigation devices or systems.

For example, geographic data is compiled (such as into a platform specification format (PSF)) to organize and/or configure the data for performing navigation-related functions and/or services, such as route calculation, route guidance, map display, speed calculation, distance and travel time functions, and other functions, by a navigation device, such as by UEs. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database 111 in a delivery format to produce one or more compiled navigation databases.

The processes described herein for providing transaction proof of location data may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

Additionally, as used herein, the term ‘circuitry’ may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular 12 device, other network device, and/or other computing device.

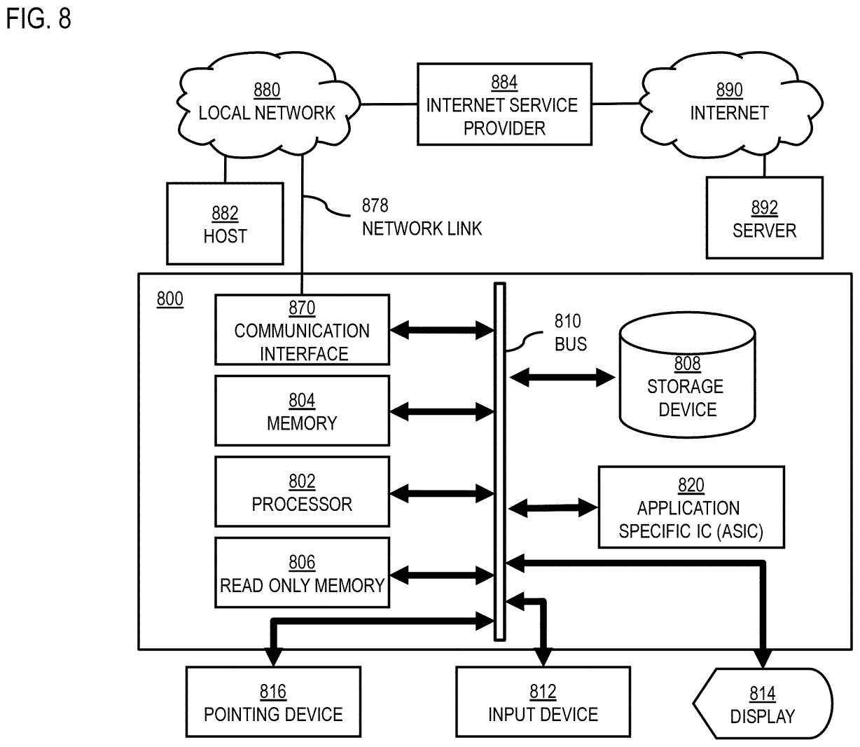

FIG. 8 illustrates a computer system 800 upon which an embodiment of the invention may be implemented. Computer system 800 is programmed (e.g., via computer program code or instructions) to provide transaction proof of location data as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 810 includes one or more parallel conductors of information so that information is transferred quickly among devices coupled to the bus 810. One or more processors 802 for processing information are coupled with the bus 810.

A processor 802 performs a set of operations on information as specified by computer program code related to providing transaction proof of location data. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations includes bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or other dynamic storage device, stores information including processor instructions for providing transaction proof of location data. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk, or flash card, for storing information, including instructions, that persists even when the computer system 800 is turned off or otherwise loses power.

Information, including instructions for providing transaction proof of location data, is provided to the bus 810 for use by the processor from an external input device 812, such as a keyboard containing alphanumeric keys operated by a human user, or a sensor. A sensor detects conditions in its vicinity and transforms those detections into physical expressions compatible with the measurable phenomenon used to represent information in computer system 800. Other external devices coupled to bus 810, used primarily for interacting with humans, include a display device 814, such as a cathode ray tube (CRT) or a liquid crystal display (LCD), or plasma screen or printer for presenting text or images, and a pointing device 816, such as a mouse or a trackball or cursor direction keys, or motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners, and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic, or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network for providing transaction proof of location data.

The term computer-readable medium is used herein to refer to any medium that participates in providing information to processor 802, including instructions for execution. Such a medium may take many forms, including, but not limited to, non-volatile media, volatile media, and transmission media. Non-volatile media include, for example, optical or magnetic disks, such as storage device 808. Volatile media include, for example, dynamic memory 804. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization, or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of the system can be deployed in various configurations within other computer systems, e.g., host 882 and server 892.

FIG. 9 illustrates a chip set 900 upon which an embodiment of the invention may be implemented. Chip set 900 is programmed to provide transaction proof of location data as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to perform specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to provide transaction proof of location data. The memory 905 also stores the data associated with or generated by the execution of the inventive steps.

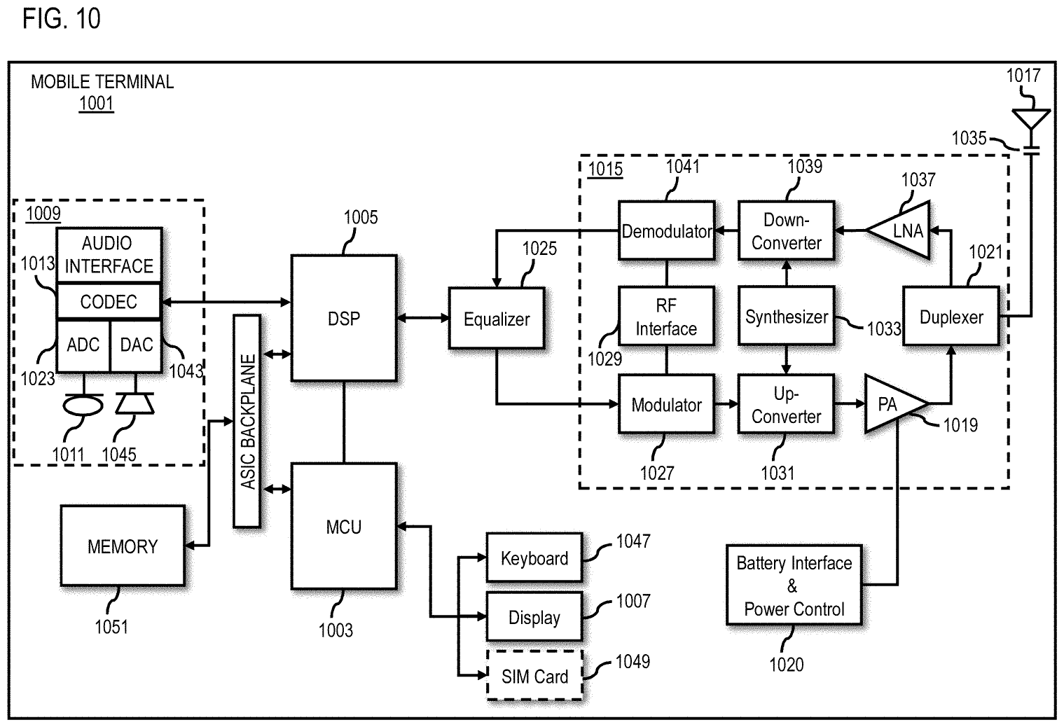

FIG. 10 is a diagram of exemplary components of a mobile terminal (e.g., UEs or components thereof) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile station functions that offer automatic contact matching. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile station 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, 5G New Radio networks, code division multiple access (CDMA), wireless fidelity (WiFi), satellite, and the like.

The encoded signals are then routed to an equalizer 1025 for compensation of any frequency-dependent impairments that occur during transmission though the air such as phase and amplitude distortion. After equalizing the bit stream, the modulator 1027 combines the signal with an RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003—which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile station 1001 to provide transaction proof of location data. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the station. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile station 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1051 may be, but not limited to, a single memory, CD, DVD, ROM, RAM, EEPROM, optical storage, or any other non-volatile or non-transitory storage medium capable of storing digital data.

An optionally incorporated SIM card 1049 carries, for instance, important information, such as the cellular phone number, the carrier supplying service, subscription details, and security information. The SIM card 1049 serves primarily to identify the mobile station 1001 on a radio network. The card 1049 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
collecting sensor data from one or more sensors of a device at a time, a location, or a combination thereof associated with a transaction, wherein the sensor data represent one or more environmental observations of the location;
generating a capsule of the one or more environmental observations;
tagging the capsule with the time of the transaction;
cryptographically signing the capsule; and
providing the cryptographically signed capsule as a proof of location.

2. The method of claim 1, further comprising:
receiving another cryptographically signed capsule from another device associated with the transaction,
wherein the another cryptographically signed capsule is generated from other sensor data collected from the another device and is cryptographically signed by the another device.

3. The method of claim 2, wherein the device cryptographically signs the another cryptographically signed capsule of the another device as part of a multiparty agreement, and wherein the another device cryptographically signs the cryptographically signed capsule to the device as part of the multiparty agreement.

4. The method of claim 3, further comprising:
providing the multiparty agreement as proof of the transaction.

5. The method of claim 1, wherein the one or more environmental observations include at least one of:
a geolocation of the device;
a mobile network carrier to which the device is connected;
a signal strength of the mobile network carrier;
a base station list of one or more base stations, one or more base station identity codes, one or more base station frequencies, or a combination thereof detected by the device;
a wireless network list comprising one or more wireless networks to which the device is connected or that can be detected by the wireless device, a wireless signal strength of the one or more wireless networks, a wireless frequency of the one or more wireless networks, or a combination thereof; or
a barometric pressure measure by the device.

6. The method of claim 1, wherein the cryptographically signed capsule is exchanged with another device using shortrange wireless communication.

7. The method of claim 6, further comprising:
periodically scanning for the another device,
wherein the cryptographically signed capsule is exchanged based on the scanning.

8. The method of claim 1, further comprising:
decrypting the one or more environmental observations from the cryptographically signed capsule to verify the proof of location.

9. The method of claim 1, wherein the cryptographically signed capsule is integrated with an identity token provided by an identity verification system.

10. The method of claim 1, further comprising:
recording the cryptographically signed capsule on a blockchain.

11. An apparatus comprising:
at least one processor; and
at least one memory including computer program code for one or more programs, the at least one memory and the computer program code configured to, with the at least one processor, cause the apparatus to perform at least the following,
collect sensor data from one or more sensors of a device at a time, a location, or a combination thereof associated with a transaction, wherein the sensor data represent one or more environmental observations of the location;
generate a capsule of the one or more environmental observations;
tag the capsule with the time of the transaction;
cryptographically sign the capsule; and
provide the cryptographically signed capsule as a proof of location.

12. The apparatus of claim 11, wherein the apparatus is further caused to:
receive another cryptographically signed capsule from another device associated with the transaction,
wherein the another cryptographically signed capsule is generated from other sensor data collected from the another device and is cryptographically signed by the another device.

13. The apparatus of claim 12, wherein the device cryptographically signs the another cryptographically signed capsule of the another device as part of a multiparty agreement, and wherein the another device cryptographically signs the cryptographically signed capsule to the device as part of the multiparty agreement.

14. The apparatus of claim 13, wherein the apparatus is further caused to:
provide the multiparty agreement as proof of the transaction.

15. The apparatus of claim 11, wherein the one or more environmental observations include at least one of:
a geolocation of the device;
a mobile network carrier to which the device is connected;
a signal strength of the mobile network carrier;
a base station list of one or more base stations, one or more base station identity codes, one or more base station frequencies, or a combination thereof detected by the device;
a wireless network list comprising one or more wireless networks to which the device is connected or that can be detected by the wireless device, a wireless signal strength of the one or more wireless networks, a wireless frequency of the one or more wireless networks, or a combination thereof; and
a barometric pressure measure by the device.

16. A non-transitory computer-readable storage medium carrying one or more sequences of one or more instructions which, when executed by one or more processors, cause an apparatus to perform:
collecting sensor data from one or more sensors of a device at a time, a location, or a combination thereof associated with a transaction, wherein the sensor data represent one or more environmental observations of the location;
generating a capsule of the one or more environmental observations;
tagging the capsule with the time of the transaction;
cryptographically signing the capsule; and
providing the cryptographically signed capsule as a proof of location.

17. The non-transitory computer-readable storage medium of claim 16, wherein the apparatus is caused to further perform:
receiving another cryptographically signed capsule from another device associated with the transaction,
wherein the another cryptographically signed capsule is generated from other sensor data collected from the another device and is cryptographically signed by the another device.

18. The non-transitory computer-readable storage medium of claim 17, wherein the device cryptographically signs the another cryptographically signed capsule of the another device as part of a multiparty agreement, and wherein the another device cryptographically signs the cryptographically signed capsule to the device as part of the multiparty agreement.

19. The non-transitory computer-readable storage medium of claim 18, wherein the apparatus is caused to further perform:
providing the multiparty agreement as proof of the transaction.

20. The non-transitory computer-readable storage medium of claim 16, wherein the one or more environmental observations include at least one of:
a geolocation of the device;
a mobile network carrier to which the device is connected;
a signal strength of the mobile network carrier;
a base station list of one or more base stations, one or more base station identity codes, one or more base station frequencies, or a combination thereof detected by the device;
a wireless network list comprising one or more wireless networks to which the device is connected or that can be detected by the wireless device, a wireless signal strength of the one or more wireless networks, a wireless frequency of the one or more wireless networks, or a combination thereof; and
a barometric pressure measure by the device.
